(19) United States
(12) Patent Application Publication
(10) Pub. No.: US 2012/0275316 A1
(43) Pub. Date: Nov. 1, 2012

(54) Failure Detection Method and Device for FCoE Virtual Link

(76) Inventor: Xiaodong Wang, Beijing (CN)

(21) Appl. No.: 13/386,860

(22) PCT Filed: Dec. 23, 2010
(86) PCT No.: PCT/CN2010/080163

§ 371 Date: Jan. 24, 2012

(30) Foreign Application Priority Data
Dec. 23, 2009 (CN) 200910262048.9

(51) Int. Cl. H04L 12/26

(52) U.S. Cl. 370/242

(57) ABSTRACT

A failure detection method and device for a FCoE virtual link. A first FCoE devices receives a Keep Alive Request packet from a Transmit switch, the Keep Alive Request packet having a response period; in response to receiving the Keep Alive Request packet, the first FCoE device creates a virtual link aging timer, configures expiration time of the timer according to the response period, and transmits a packet for maintaining the FCoE virtual link to a second FCoE device. If the first FCoE device does not receive a packet for maintaining the FCoE virtual link returned by the second FCoE device by the time the timer expires, the first FCoE device detects that the FCoE virtual link between the first FCoE device and the second FCoE device is in failure.

### BACKGROUND OF THE INVENTION

FCoE protocol is a transmission protocol in which Fiber Channel (FC) protocol is born over Ethernet. In a FCoE network, a device supporting the FCoE protocol is called a FCoE device; e.g., a switch supporting the FCoE protocol is called a FCoE Forwarder (FCF) switch, and a communication entity supporting the FCoE protocol is called an Ethernet Node (ENode). In a FCoE network, an Ethernet switch which does not support the FCoE protocol but can transmit FCoE packets is called a Transmit switch. The FCoE protocol is able to discover FCFs and ENodes and establish and maintain virtual links between them. However, it can take a long time to discover that a virtual link has become invalid (if a link in the network is down for instance).

### BRIEF DESCRIPTION OF THE DRAWINGS

FIG. 1 is a schematic diagram illustrating the structure of a FCoE network in the prior art.

FIG. 2 is a flowchart illustrating a maintenance procedure of a FCoE virtual link between a FCF switch and an ENode in the prior art.

FIG. 3 is a flowchart illustrating a failure detection method for a FCoE virtual link according to an example.

FIG. 4 is a schematic diagram illustrating the structure of another FCoE network.

FIG. 5 is a flowchart illustrating a failure detection method for a FCoE virtual link according to an example.

### DETAILED DESCRIPTION

FIG. 1 is a schematic diagram illustrating an example of a FCoE network. In the FCoE network shown in FIG. 1, before an FCF switch 20 and an ENode 10 exchange a FCoE packet, it is necessary to establish and maintain a FCoE virtual link between the FCF switch 20 and the ENode 10. FCoE Initialization Protocol (FIP) is a protocol for initiating a FCoE virtual link between FCoE devices, e.g. between an FCF switch and an ENode or between two FCF switches.

The FIP includes three procedures, i.e. a discovery procedure, a virtual link initiation procedure and a virtual link maintenance procedure. The discovery procedure is a procedure in which a FCoE device discovers an opposite FCoE device, identifies the identity of the opposite FCoE device and negotiates capability parameters. The virtual link initiation procedure is a procedure in which a certain FCoE device establishes a FCoE virtual link to another FCoE device in the network after discovering the another FCoE device. The virtual link maintenance procedure is a procedure in which a current FCoE device transmits a maintenance packet periodically to maintain a FCoE virtual link, and determines the state of a FCoE virtual link by monitoring a maintenance packet transmitted by an opposite FCoE device.

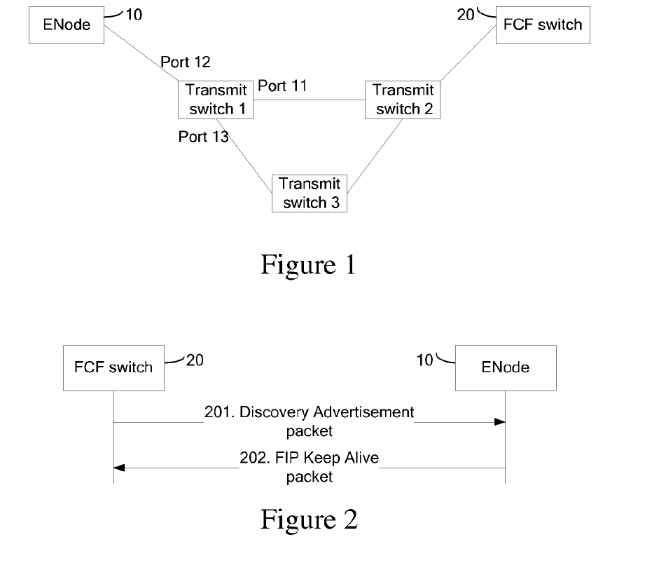

Referring to FIG. 2, FIG. 2 is a flowchart illustrating a maintenance procedure of a FCoE virtual link between a FCF switch 20 and an ENode 10 in the prior art. The maintenance procedure of the FCoE virtual link includes the following steps.

Step 201: the FCF switch 20 transmits a Discovery Advertisement packet to the ENode 10 periodically; the transmission period is FKA_ADV_PERIOD. In this step, the Discovery Advertisement packet is a packet for maintaining the FCoE virtual link which is transmitted to the ENode 10 by the FCF switch 20.

If the ENode 10 receives the Discovery Advertisement packet, the ENode 10 goes on maintaining the FCoE virtual link between the FCF switch 20 and the ENode 10; if the ENode 10 does not receive the Discovery Advertisement packet within 2.5×FKA_ADV_PERIOD, the ENode 10 determines that the FCoE virtual link is invalid, and does not maintain the FCoE virtual link.

Step 202: the ENode 10 transmits a FIP Keep Alive packet to the FCF switch 20 periodically; the transmission period is also FKA_ADV_PERIOD. In this step, the FIP Keep Alive packet is a packet for maintaining the FCoE virtual link which is transmitted to the FCF switch 20 by the ENode 10.

If the FCF switch 20 receives the FIP Keep Alive packet, the FCF switch goes on maintaining the FCoE virtual link between the FCF switch 20 and the ENode 10; if the FCF switch 20 does not receive the FIP Keep Alive packet within 2.5×FKA_ADV_PERIOD, the FCF switch 20 determines that the FCoE virtual link is invalid, and does not maintain the FCoE virtual link.

The FKA_ADV_PERIOD is set up in each device by the manufacturer or system administrator. Since the FKA_ADV_PERIOD is 8 s by default, it takes the FCoE device 20 s to detect the invalidation of the FCoE virtual link when the FCoE virtual link is invalid, which may result in the FCF switch 20 and the ENode 10 being abnormal for a long time. If the FKA_ADV_PERIOD is decreased, the time period can be reduced. But, because the transmission period becomes small, a large number of control packets need to be transmitted in the network, which will influence the network bandwidth. Therefore, it would be advantageous to more rapidly detect whether the FCoE virtual link is invalid without influencing the network bandwidth.

The following examples provide a failure detection method for a FCoE virtual link, which includes that the following: when there is a network failure, a FCoE virtual link between two FCoE devices in the network may be in failure; in this case, a FCoE device may be informed to transmit a packet for maintaining the FCoE virtual link to an opposite FCoE device which has the FCoE virtual link with the FCoE device. If the FCoE device can not receive the response of the opposite FCoE device in time, the FCoE device can detect that the FCoE virtual link between the FCoE device and the opposite FCoE device is in failure. In addition, when there is a network failure, Transmit switches at two ends of the FCoE virtual link which is in failure can discover the network failure, and so the Transmit switches may inform the FCoE device.

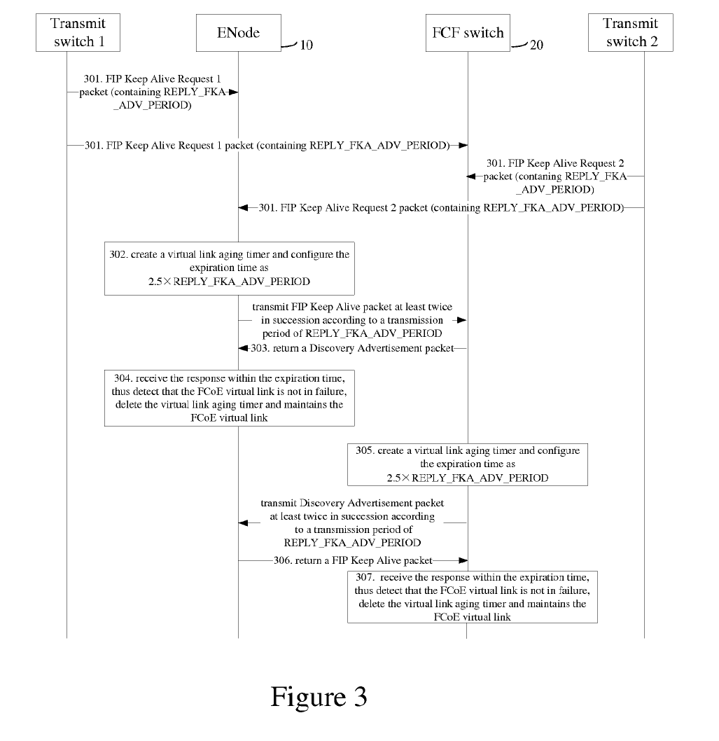

Referring to FIG. 3, FIG. 3 is a flowchart illustrating a failure detection method for a FCoE virtual link according to one example. The failure detection method will be described with reference to FIG. 1. As shown in FIG. 1, a Transmit switch 1, a Transmit switch 2 and a Transmit switch 3 act as transmission devices and are located between the FCoE devices, e.g. located between an ENode 10 and a FCF switch 20. Suppose a FCoE virtual link between the Transmit switch 1 and the Transmit switch 2 is in failure, the failure detection method includes the following steps.

Step 301: the FCoE virtual link between the Transmit switch 1 and the Transmit switch 2 is in failure. Both the Transmit switch 1 and the Transmit switch 2 discover the failure, and generate and transmit FIP Keep Alive Request packets. Compared to a conventional FIP Keep Alive Request packet, these packets in addition contain a field specifying the REPLY_FKA_ADV_PERIOD. The packet transmitted by the Transmit switch 1 is called a FIP Keep Alive Request 1 packet, and the packet transmitted by the Transmit switch 2 is called a FIP Keep Alive Request 2 packet.

In this step, the REPLY_FKA_ADV_PERIOD contained in the FIP Keep Alive Request 1 packet and the FIP Keep Alive Request 2 packet are both configured as 100 ms. The REPLY_FKA_ADV_PERIOD may be configured as another value according to practical applications, e.g. it may be configured as any value smaller than 8 s and is preferably configured as any value between 100 ms and 1000 ms.

In this step, the Transmit switches may transmit the FIP Keep Alive Request packets through other ports except ports on the failed FCoE virtual link. Taking the Transmit switch 1 as an example, the FCoE virtual link on which a port 11 is located is in failure, the Transmit switch 1 may transmit the FIP Keep Alive Request 1 packet through a port 12 and a port 13.

Step 302: the ENode 10 receives the FIP Keep Alive Request 1 packet and the FIP Keep Alive Request 2 packet. The transmission path of the FIP Keep Alive Request 2 packet from the Transmit switch 2 is Transmit switch 2->Transmit switch 3->Transmit switch 1->ENode 10.

According to the received FIP Keep Alive Request packets, the ENode 10 creates a virtual link aging timer, configures the expiration time of the virtual link aging timer as 2.5×REPLY_FKA_ADV_PERIOD=250 ms, and transmits a FIP Keep Alive packet at least twice in succession according to a transmission period of 100 ms. In this example, the FIP Keep Alive packet is a packet for maintaining the FCoE virtual link which is transmitted to the FCF switch 20 by the ENode 10.

Step 303: the FCF switch 20 receives the FIP Keep Alive packet transmitted by the ENode 10 (the transmission path of the FIP Keep Alive packet is ENode 10->Transmit switch 1->Transmit switch 3->Transmit switch 2->FCF switch 20), and returns a Discovery Advertisement packet to the ENode 10 according to a method in the prior art. In this example, the Discovery Advertisement packet is a packet for maintaining the FCoE virtual link which is transmitted to the ENode 10 by the FCF switch 20.

Step 304: the ENode 10 receives the Discovery Advertisement packet returned by the FCF switch 20 within the expiration time of the virtual link aging timer, and thus detects that the FCoE virtual link between the ENode 10 and the FCF switch 20 is not in failure; then the ENode 10 deletes the virtual link aging timer and maintains the FCoE virtual link according to the original protocol.

The above Steps 302 to 304 represent a procedure in which the ENode 10 detects whether the FCoE virtual link is in failure. The following Steps 305 to 307 represent a procedure in which the FCF switch 20 detects whether the FCoE virtual link is in failure, it is similar to the procedure in which the ENode 10 detects whether the FCoE virtual link is in failure. The two procedures are performed synchronously, and do not influence with each other.

Step 305: the FCF switch 20 receives the FIP Keep Alive Request 1 packet and the FIP Keep Alive Request 2 packet. The transmission path of the FIP Keep Alive Request 1 packet from the Transmit switch 1 is Transmit switch 1->Transmit switch 3->Transmit switch 2->FCF switch 20.

The FCF switch 20 creates a virtual link aging timer according to the FIP Keep Alive Request packets, configures the expiration time of the virtual link aging timer as 2.5×REPLY_FKA_ADV_PERIOD=250 ms, and transmits a Discovery Advertisement packet at least twice in succession according to the transmission period of 100 ms.

Step 306: the ENode 10 receives the Discovery Advertisement packet transmitted by the FCF switch 20 (the transmission path is FCF switch 20->Transmit switch 2->Transmit switch 3->Transmit switch 1->ENode 10), and returns a FIP Keep Alive packet to the FCF switch 20 according to a method in the prior art.

Step 307: the FCF switch 20 receives the FIP Keep Alive packet returned by the ENode 10 within the expiration time of the virtual link aging timer, and thus detects that the FCoE virtual link between the FCF switch 20 and the ENode 10 is not in failure; at this time, the FCF switch 20 deletes the virtual link aging timer and maintains the FCoE virtual link according to the original protocol.

As can be seen, in this example, since the Transmit switch 1, the Transmit switch 2 and the Transmit switch 3 have a reticular structure, the failure of the FCoE virtual link between the Transmit switch 1 and the Transmit switch 2 does not influence the FCoE virtual link between the ENode 10 and the FCF switch 20, and thus the ENode 10 and the FCF switch 20 can detect that the FCoE virtual link is not in failure.

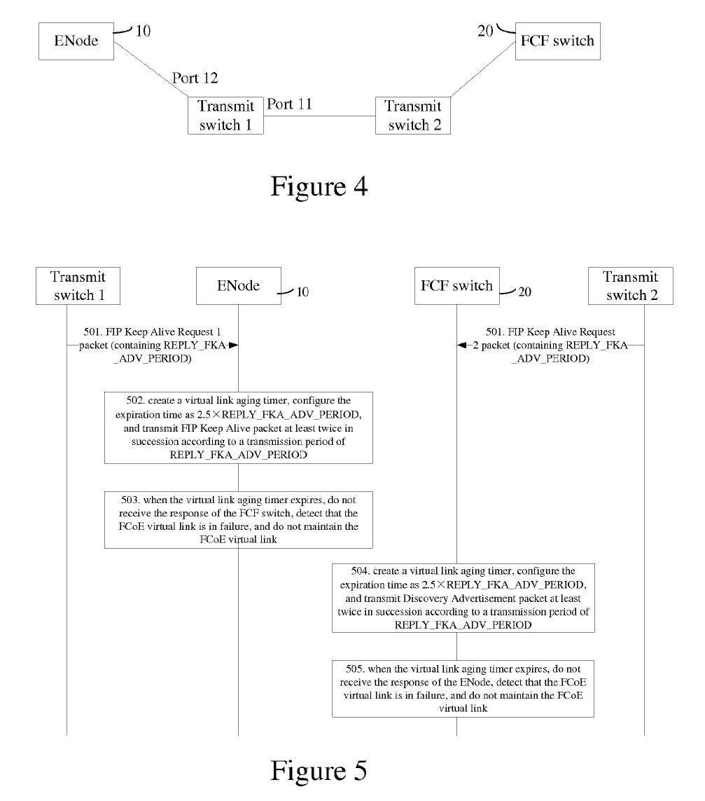

FIG. 4 is a schematic diagram illustrating the structure of another FCoE network in the prior art. As shown in FIG. 4, the FCoE network includes the Transmit switch 1 and the Transmit switch 2.

Hereinafter, another example is described. In this example, the ENode 10 and the FCF switch 20 will detect that a FCoE virtual link is in failure.

Referring to FIG. 5, FIG. 5 is a flowchart illustrating a failure detection method for a FCoE virtual link. The failure detection method is described with reference to the FCoE network shown in FIG. 4. As shown in FIG. 4, the Transmit switch 1 and the Transmit switch 2 are transmission devices which are located between FCoE devices, e.g. located between the ENode 10 and the FCF switch 20. Suppose a FCoE virtual link between Transmit switch 1 and Transmit switch 2 is in failure, the failure detection method includes the following steps.

Step 501: the FCoE virtual link between the Transmit switch 1 and the Transmit switch 2 is in failure. Both the Transmit switch 1 and the Transmit switch 2 discover the failure, and generate and transmit FIP Keep Alive Request packets containing REPLY_FKA_ADV_PERIOD (configured as 100 ms). The packet transmitted by the Transmit switch 1 is called a FIP Keep Alive Request 1 packet, and the packet transmitted by the Transmit switch 2 is called a FIP Keep Alive Request 2 packet.

In this step, the Transmit switches may transmit the FIP Keep Alive Request packets through other ports except ports on the failed FCoE virtual link. Taking the Transmit switch 1 as an example, the FCoE virtual link on which the port 11 is located is in failure, the Transmit switch 1 may transmit the FIP Keep Alive Request 1 packet through the port 12.

Step 502: the ENode 10 receives the FIP Keep Alive Request 1 packet, creates a virtual link aging timer according to the received FIP Keep Alive Request 1 packet, configures the expiration time of the virtual link aging timer as 2.5×REPLY_FKA_ADV_PERIOD=250 ms, and transmits a FIP Keep Alive packet at least twice in succession according to a transmission period of 100 ms. In this example, the FIP Keep Alive packet is a packet for maintaining the FCoE virtual link which is transmitted to the FCF switch 20 by the ENode 10.

Step 503: due to the network failure, the FCF switch 20 can not receive the FIP Keep Alive packet transmitted by the ENode 10, and thus can not return a Discovery Advertisement packet to the ENode 10; when the virtual link aging timer of the ENode 10 expires, since the ENode 10 does not receive the response of the FCF switch 20, the EN ode 10 detects that the FCoE virtual link between the ENode 10 and the FCF switch 20 is in failure, and thus does not maintain the FCoE virtual link between the ENode 10 and the FCF switch 20.

The above Steps 502 and 503 are a procedure in which the ENode 10 detects whether the FCoE virtual link is in failure. The following Steps 504 and 505 are a procedure in which the FCF switch 20 detects whether the FCoE virtual link is in failure, and this procedure is similar to the procedure in which the ENode 10 detects whether the FCoE virtual link is in failure. The two procedures are performed synchronously, and do not influence with each other.

Step 504: the FCF switch 20 receives the FIP Keep Alive Request 2 packet.

The FCF switch 20 creates a virtual link aging timer according to the FIP Keep Alive Request 2 packet, configures the expiration time of the virtual link aging timer as 2.5×REPLY_FKA_ADV_PERIOD=250 ms, and transmits a Discovery Advertisement packet at least twice in succession according to a transmission period of 100 ms. In this example, the Discovery Advertisement packet is a packet for maintaining the FCoE virtual link which is transmitted to the ENode 10 by the FCF switch 20.

Step 505: due to the network failure, the ENode 10 cannot receive the Discovery Advertisement packet transmitted by the FCF switch 20, and thus cannot return a FIP Keep Alive packet to the FCF switch. When the virtual link aging timer of the FCF switch 20 expires, since the FCF switch 20 does not receive the response of the ENode 10, the FCF switch 20 detects that the FCoE virtual link between the FCF switch 20 and the ENode 10 is in failure, and thus does not maintain the FCoE virtual link between the FCF switch 20 and the ENode 10.

As can be seen, in this example, the failure of the FCoE virtual link between the Transmit switch 1 and the Transmit switch 2 influences the FCoE virtual link between the ENode 10 and the FCF switch 20, and thus the ENode 10 and the FCF switch 20 can detect that the FCoE virtual link is in failure.

In the above two examples, the FIP Keep Alive Request packet further contains a transmission entity type bite (T_Bit) as well as the REPLY_FKA_ADV_PERIOD, for carrying type information of the device transmitting the FIP Keep Alive Request packet. For example, when the length of T_Bit is 2 bits and the value of the T_Bit is “00”, this indicates that the device transmitting the FIP Keep Alive Request packet is a Transmit switch.

Herein, certain advantages of the examples of FIGS. 3 and 5 will be described briefly by way of comparison with the prior art. In the prior art, both the ENode 10 and the FCF switch 20 transmit the packet for maintaining the FCoE virtual link according to a transmission period of FKA_ADV_PERIOD. Specifically, the ENode 10 transmits the FIP Keep Alive packet, and the FCF switch 20 transmits the Discovery Advertisement packet. If one of the ENode 10 and the FCF switch 20 can not receive the response of the opposite device in time, the one of the ENode 10 and the FCF switch 20 detects that the FCoE virtual link is in failure. Though the failure of the FCoE virtual link can be detected in the prior art, the transmission period of transmitting the packet for maintaining the FCoE virtual link (FKA_ADV_PERIOD) is usually configured as 8 s in the prior art, while the transmission period of transmitting the packet for maintaining the FCoE virtual link (REPLY_FKA_ADV_PERIOD) may be configured as a smaller value in the above examples, e.g. any value between 100 and 1000 ms, and thus the failure of the FCoE virtual link can be detected rapidly in the above examples. In addition, the method of the above examples will not be executed unless there is a network failure, which can guarantee that network burden is not increased when the network is normal, and the number of packets for maintaining the FCoE virtual link transmitted in the network is decreased.

In addition, in the above two examples, the ENode 10 transmits the FIP Keep Alive packet at least twice in succession, and the FCF switch 20 transmits the Discovery Advertisement packet at least twice in succession, so as to guarantee the correctness of the failure detection of the FCoE virtual link and avoid detection error because of occasional transmission delay.

In the above two examples, the REPLY_FKA_ADV_PERIOD contained in the FIP Keep Alive Request packets transmitted by all Transmit switches has the same value, and in the above examples, the REPLY_FKA_ADV_PERIOD contained in the FIP Keep Alive Request packets transmitted by different Transmit switches may have different values. In this case, the FCoE device may configure the expiration time of the virtual link aging timer according to the REPLY_FKA_ADV_PERIOD having the smallest value in the FIP Keep Alive Request packets, and transmits the packet for maintaining the FCoE virtual link according to a transmission period of the REPLY_FKA_ADV_PERIOD having the smallest value.

Further examples provide a failure detection system for a FCoE virtual link, including:

a Transmit switch, adapted to transmit a FIP Keep Alive Request packet containing a response period when discovering a network failure;

a FCoE device, adapted to receive the FIP Keep Alive Request packet, create a virtual link aging timer, configure expiration time of the virtual link aging timer according to the response period, and transmit a packet for maintaining the FCoE virtual link to an opposite FCoE device; if the FCoE device does not receive the response of the opposite FCoE device when the virtual link aging timer expires, detect that the FCoE virtual link between the FCoE device and the opposite FCoE device is in failure.

Another example provides a Transmit switch, including:

a detecting module, adapted to detect whether there is a network failure, and indicate a transmitting module to transmit a FIP Keep Alive Request packet when discovering the network failure; and

the transmitting module, adapted to transmit the FIP Keep Alive Request containing a response period to a FCoE device according to the indication of the detecting module.

Another example provides an FCF switch, including:

a first receiving module, adapted to receive a FIP Keep Alive Request packet from a Transmit switch;

a first timer module, adapted to create a virtual link aging timer, and configure expiration time of the virtual link aging timer according to a response period contained in the FIP Keep Alive Request packet;

a first transmitting module, adapted to transmit a Discovery Advertisement packet to an opposite ENode;

a first detecting module, adapted to determine whether the FCF switch receives a FIP Keep Alive packet returned by the opposite ENode when the virtual link aging timer expires; if the FCF switch does not receive the FIP Keep Alive packet, detect that a FCoE virtual link between the FCF switch and the opposite ENode is in failure.

Another example provides an ENode, including:

a second receiving module, adapted to receive a FIP Keep Alive Request packet from a Transmit switch;

a second timer module, adapted to create a virtual link aging timer, and configure expiration time of the virtual link aging timer according to a response period contained in the FIP Keep Alive Request packet;

a second transmitting module, adapted to transmit a FIP Keep Alive packet to an opposite FCF switch;

a second detecting module, adapted to determine whether the ENode receives a Discovery Advertisement packet returned by the opposite FCF switch when the virtual link aging timer expires; if the ENode does not receive the Discovery Advertisement packet, detect that a FCoE virtual link between the ENode and the opposite FCF switch is in failure.

In the failure detection method, system and device for a FCoE virtual link according to one example, the Transmit switch can discover the network failure and transmit the FIP Keep Alive Request packet containing a response period; the response period may be configured as a smaller value; the FCoE device in the network receives the FIP Keep Alive Request packet, configures the expiration time of the virtual link aging timer according to the response period, and transmits a packet for maintaining the FCoE virtual link to the opposite FCoE device; if the FCoE device does not receives the response of the opposite FCoE device when the virtual link aging timer expires, the FCoE device detects that the FCoE virtual link between the FCoE device and the opposite FCoE device is in failure. By using the method, when an established FCoE virtual link is in failure, FCoE devices at two ends of the FCoE virtual link transmit a packet for maintaining the FCoE virtual link according to a smaller transmission period; in this way, it can be detected rapidly whether the FCoE virtual link is invalid without influencing the network bandwidth.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A failure detection method for a Fibre Channel over Ethernet (FCoE) virtual link, comprising:
a first FCoE device receiving a Keep Alive Request packet from a Transmit switch, the Keep Alive Request packet containing a response period;
in response to receiving the Keep Alive Request packet, the first FCoE device creating a virtual link aging timer, configuring expiration time of the virtual link aging timer according to the response period, and transmitting a packet for maintaining the FCoE virtual link to a second FCoE device; if the first FCoE device does not receive a packet for maintaining the FCoE virtual link returned by the second FCoE device by the time the virtual link aging timer expires, detecting that the FCoE virtual link between the first FCoE device and the second FCoE device is in failure.

2. The method of claim 1, wherein the Keep Alive Request packet transmitted by the Transmit switch is a FCoE Initialization Protocol (FIP) packet.

3. The method of claim 1, wherein the first FCoE device is a FCoE Forwarders (FCF) switch, and the second FCoE device is an Ethernet Node (ENode);
the step of configuring expiration time of the virtual link aging timer according to the response period, and transmitting a packet for maintaining the FCoE virtual link to a second FCoE device comprises: configuring, by the FCF switch, the expiration time as 2.5× the response period, and transmitting a Discovery Advertisement packet to the ENode;
the step of detecting that the FCoE virtual link between the first FCoE device and the second FCoE device is in failure comprises: if the FCF switch does not receives a Keep Alive packet returned by the ENode when the virtual link aging timer expires, detecting that the FCoE virtual link between the FCF switch and the ENode is in failure.

4. The method of claim 1, wherein the first FCoE device is an ENode, and the second FCoE device is an FCF switch;
the step of configuring expiration time of the virtual link aging timer according to the response period, and transmitting a packet for maintaining the FCoE virtual link to a second FCoE device comprises: configuring, by the ENode, the expiration time as 2.5× the response period, and transmitting a Keep Alive packet to the FCF switch;
the step of detecting that the FCoE virtual link between the first FCoE device and the second FCoE device is in failure comprises: if the ENode does not receives a Discovery Advertisement packet returned by the FCF switch when the virtual link aging timer expires, detecting that the FCoE virtual link between the ENode and the FCF switch is in failure.

5. The method of claim 1, wherein the first FCoE device transmits the Keep Alive packet to the second FCoE device at least twice in succession.

6. The method of claim 1, further comprising:
if the first FCoE device receives the packet for maintaining the FCoE virtual link returned by the second FCoE device when the virtual link aging timer expires, detecting, by the first FCoE device, that the FCoE virtual link between the first FCoE device and the second FCoE device is not in failure, deleting the virtual link aging timer, and maintaining the FCoE virtual link.

7. The method of claim 1, wherein the Keep Alive Request packet contains a transmission entity type byte, for carrying type information of the device transmitting the Keep Alive Request packet.

8. The method of claim 1, wherein when the first FCoE device receives Keep Alive Request packets transmitted by multiple Transmit switches at the same time, configuring the expiration time according to a response period having the smallest value contained in the Keep Alive Request packets and transmitting the packet for maintaining the FCoE virtual link.

9. The method of claim 1, wherein the response period is any value between 100 ms and 1000 ms.

10. A Transmit switch, located between Fibre Channel over Ethernet (FCoE) devices, comprising:
a detecting module, adapted to detect whether there is a network failure, and indicate a transmitting module to transmit a Keep Alive Request packet when discovering the network failure; and
the transmitting module, adapted to transmit the Keep Alive Request packet containing a response period to a FCoE device according to the indication of the detecting module.

11. The Transmit switch of claim 10, wherein the response period is any value between 100 ms and 1000 ms.

12. The Transmit switch of claim 10, wherein the Keep Alive Request packet transmitted by the transmitting module is a FCoE Initialization Protocol (FIP) packet.

13. A Fibre Channel over Ethernet (FCoE) device, comprising:
a receiving module, adapted to receive a Keep Alive Request packet from a Transmit switch located between the FCoE device and another FCoE device; the Keep Alive Request packet containing a response period;
a timer module, adapted to create a virtual link aging timer, and configure expiration time of the virtual link aging timer according to a response period contained in the received Keep Alive Request packet;
a transmitting module, adapted to transmit a packet for maintaining a FCoE virtual link to the another FCoE device in response to the Keep Alive Request packet received from the Transmit switch;
a detecting module, adapted to determine whether the FCoE device receives a packet for maintaining the FCoE virtual link from the another FCoE device when the virtual link aging timer expires; if the FCoE device does not receive the packet for maintaining the FCoE virtual link, detect that the FCoE virtual link between the FCoE device and the another FCoE device is in failure.

14. The FCoE device of claim 13, wherein the FCoE device is a FCoE Forwarders (FCF) switch, and the another FCoE device is an Ethernet Node (ENode); or the FCoE device is an ENode, and the another FCoE device is an FCF switch.

15. The FCoE device of claim 14, wherein if the FCoE device is an FCF switch and the another FCoE device is an ENode, the packet for maintaining the FCoE virtual link transmitted to the another FCoE device is a Discovery Advertisement packet, and the packet for maintaining the FCoE virtual link returned by the another FCoE device is a Keep Alive packet;
if the FCoE device is an ENode and the another FCoE device is an FCF switch, the packet for maintaining the FCoE virtual link transmitted to the another FCoE device is a Keep Alive packet, and the packet for maintaining the FCoE virtual link returned by the another FCoE device is a Discovery Advertisement packet.

16. The FCoE device of claim 13, wherein the response period is any value between 100 ms and 1000 ms.

17. The FCoE device of claim 13, wherein the Keep Alive Request packet transmitted by the transmitting module is a FCoE Initialization Protocol (FIP) packet.
